(19) United States
(12) Patent Application Publication
(10) Pub. No.: US 2020/0398842 A1
(43) Pub. Date: Dec. 24, 2020

(54) Vehicle Speed Control Device And Vehicle Speed Control Method

(71) Applicant: Meidensha Corporation, Tokyo (JP)

(72) Inventors: Kento Yoshida, Tokyo (JP); Hironobu Fukai, Tokyo (JP)

(73) Assignee: Meidensha Corporation, Tokyo (JP)

(21) Appl. No.: 16/969,416

(22) PCT Filed: Dec. 21, 2018
(86) PCT No.: PCT/JP2018/047201

§ 371 Date: Aug. 12, 2020

(30) Foreign Application Priority Data
Feb. 15, 2018 (JP) 2018-024648

(51) Int. Cl. B60W 30/188; G06N 3/04; B60W 10/04; B60W 30/14

(52) U.S. Cl. CPC B60W 30/188; G06N 3/04; B60W 2510/0676; B60W 30/143; B60W 2510/0604; B60W 10/04

(57) ABSTRACT

[Problem] To provide a vehicle speed control device and a vehicle speed control method that allow vehicle speed commands to be followed with high precision. [Solution] Provided is a vehicle speed control device 10 for controlling driving of a vehicle 1 in accordance with a defined vehicle speed command v₁ by changing an accelerator position of the vehicle 1, wherein the vehicle speed control device 10 comprises: an accelerator position change amount computation unit 16 that computes an accelerator position change amount θ_{FF} based on a current vehicle speed v_{det} and a requested drive power F_{ref} necessary to fulfill the vehicle speed command v₁, computed based on the vehicle speed command v₁; and an accelerator position changing unit 12 that changes the accelerator position based on the accelerator position change amount θ_{FF}; wherein the accelerator position change amount computation unit 16 computes the accelerator position change amount θ_{FF} by using a machine learning device that has been trained by using, as training data, driving history data 17 including drive powers, vehicle speeds, and accelerator position change amounts of the vehicle 1 while being driven.

### TECHNICAL FIELD

The present invention relates to a vehicle speed control device and a vehicle speed control method.

### BACKGROUND

Generally, when manufacturing and selling vehicles such as standard-sized automobiles, it is necessary to measure the fuel consumption and exhaust gases generated when the vehicle is driven in a specific driving pattern (mode) defined by a country or a region, and to display the results thereof.

The mode may, for example, be represented by a graph as the relationship between the time elapsed since starting to drive and the vehicle speed to be reached at that time. The vehicle speed to be reached is sometimes called a vehicle speed command in that it represents a command to the vehicle regarding the speed to be reached.

Tests regarding the fuel consumption and exhaust gases as mentioned above are performed by mounting a vehicle on a chassis dynamometer and driving the vehicle in accordance with the mode by means of an automatic driving device installed in the vehicle.

A tolerable error range is defined for a vehicle speed command. If the vehicle speed goes outside the tolerable error range, the test becomes invalid. Thus, the capability to closely follow vehicle speed commands is sought in automatic driving devices. Methods for controlling the vehicle include feed-forward control and feedback control. However, with feedback control, it is not easy to improve the speed-following capability due to response lag and the like. Therefore, it is particularly important to improve the speed-following capability of the vehicle by means of feed-forward control.

Such feed-forward control is sometimes implemented by means of a drive power characteristic map in which the relationship between the drive power and the vehicle speed in the steady state, when the vehicle is driven with a constant accelerator position, is measured and recorded in advance. The drive power characteristic map is represented, for example, as a three-dimensional graph having three axes XYZ. For example, when the drive power is indicated by the X axis and the vehicle speed is indicated by the Y axis, the accelerator position at the intersection thereof is expressed as the value on the Z axis. In other words, in the case in which a drive power characteristic map is used, during vehicle drive control, when the vehicle speed detected at the current time and the drive power required to fulfill the next vehicle speed command are input, an accelerator position that has been determined as being able to fulfill the vehicle speed command is output.
Document 1 discloses a vehicle speed control device provided with a drive power characteristic map as mentioned above.

### CITATION LIST

### Patent Literature

Patent Document 1: JP 2005-297872 A

### SUMMARY OF INVENTION

### Technical Problem

In general, a drive power characteristic map, as mentioned above, is implemented, for example, by measuring the relationship between one or two inputs and the accelerator position when a vehicle is driven with a constant accelerator position. In other words, for input values on the drive power characteristic map that were not actually measured, the accelerator position is calculated and recorded, for example, by linear interpolation based on the values of the accelerator position for actually measured input values located in the vicinity thereof.

For this reason, for example, regarding the input values that were not actually measured, if the accelerator position includes special values or complicated characteristics that cannot be calculated by interpolation, then there are limits on how much the speed-following precision in response to vehicle speed commands can be improved.

Additionally, for example, in a drive power characteristic map in which two inputs are used, when a new element of some kind is to be added as an input, the number of dimensions from the inputs alone makes the map three-dimensional. In other words, the number of combinations of values at which the accelerator position must be measured increases significantly.

Thus, when a drive power characteristic map is used, it is not realistic to increase the number of elements that are used as inputs in order to improve the speed-following precision in response to vehicle speed commands.

Vehicle speed control that allows vehicle speed commands to be followed with higher precision than by conventional control is desired.

The problem to be solved by the present invention is that of providing a vehicle speed control device and a vehicle speed control method that allow vehicle speed commands to be followed with high precision.

### Solution to Problem

The present invention employs the means described below in order to solve the above-mentioned problem. In other words, the present invention provides a vehicle speed control device for controlling the driving of a vehicle in accordance with a defined vehicle speed command by changing an accelerator position of the vehicle, wherein the vehicle speed control device comprises: an accelerator position change amount computation unit that computes an accelerator position change amount based on a current vehicle speed and a requested drive power necessary to fulfill the vehicle speed command, computed based on the vehicle speed command; and an accelerator position changing unit that changes the accelerator position based on the accelerator position change amount; wherein the accelerator position change amount computation unit computes the accelerator position change amount by using a machine learning device that has been trained by using, as training data, driving history data including drive powers, vehicle speeds, and accelerator position change amounts of the vehicle while being driven.

Additionally, the present invention provides a vehicle speed control method for controlling the driving of a vehicle in accordance with a defined vehicle speed command by changing an accelerator position of the vehicle, wherein the vehicle speed control method comprises: computing an accelerator position change amount based on a current vehicle speed and a requested drive power necessary to fulfill the vehicle speed command, computed based on the vehicle speed command, by using a machine learning device that has been trained by using, as training data, driving history data including drive powers, vehicle speeds, and accelerator position change amounts of the vehicle while being driven; and changing the accelerator position based on the accelerator position change amount.

### Effects of Invention

According to the present invention, it is possible to provide a vehicle speed control device and a vehicle speed control method that allow vehicle speed commands to be followed with high precision.

### BRIEF DESCRIPTION OF DRAWINGS

FIG. 1 is a diagram for explaining a vehicle speed control device according to an embodiment of the present invention.

FIG. 2 is a block diagram of a vehicle speed control device according to the aforementioned embodiment.

FIG. 3 is a diagram for explaining a machine learning device constituting an accelerator position change amount computation unit according to the aforementioned embodiment.

FIG. 4 is a flow chart of a vehicle speed control method according to the aforementioned embodiment.

FIG. 5 is a block diagram of a vehicle speed control device according to a first modified example of the aforementioned embodiment.

FIG. 6 is a block diagram of a vehicle speed control device according to a second modified example of the aforementioned embodiment.

FIG. 7 is a graph of experimental results relating to the aforementioned embodiment.

FIG. 8 is a graph of experimental results relating to the aforementioned embodiment.

### DESCRIPTION OF EMBODIMENTS

Hereinafter, embodiments of the present invention will be explained in detail with reference to the drawings.

The vehicle speed control device according to the present invention is for controlling the driving of a vehicle in accordance with a defined vehicle speed command by changing the accelerator position of the vehicle. The vehicle speed control device comprises: an accelerator position change amount computation unit that computes an accelerator position change amount based on a current vehicle speed and a requested drive power necessary to fulfill the vehicle speed command, computed based on the vehicle speed command; and an accelerator position changing unit that changes the accelerator position based on the accelerator position change amount. The accelerator position change amount computation unit computes the accelerator position change amount by using a machine learning device that has been trained by using, as training data, driving history data including drive powers, vehicle speeds, and accelerator position change amounts of the vehicle while being driven.

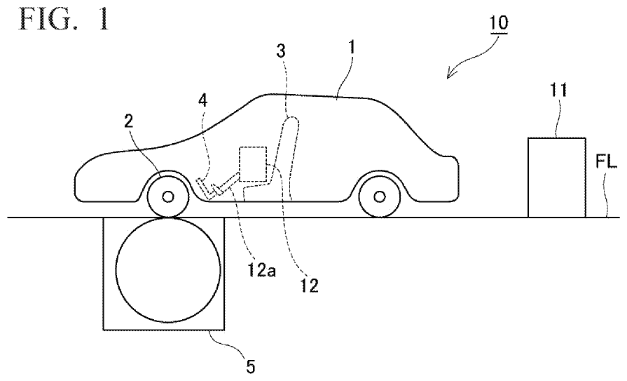

FIG. 1 is a diagram for explaining a vehicle speed control device according to an embodiment. A vehicle 1 is provided on a floor surface FL. A chassis dynamometer 5 is provided below the floor surface FL. The vehicle 1 is positioned so that a drive wheel 2 of the vehicle 1 is mounted on the chassis dynamometer 5. When the vehicle 1 is driven and the drive wheel 2 rotates, the chassis dynamometer 5 rotates in the opposite direction.

The vehicle speed control device 10 in the present embodiment controls the driving of the vehicle 1 in accordance with a defined driving pattern (mode) by changing the accelerator position of the vehicle 1. More specifically, the vehicle speed control device 10 controls the driving of the vehicle 1 so as to follow vehicle speed commands, which are vehicle speeds to be reached at certain times in accordance with the time elapsed since starting to drive.

The vehicle speed control device 10 comprises a control terminal 11 and an accelerator position changing unit 12 that are provided so as to be able to communicate with each other.

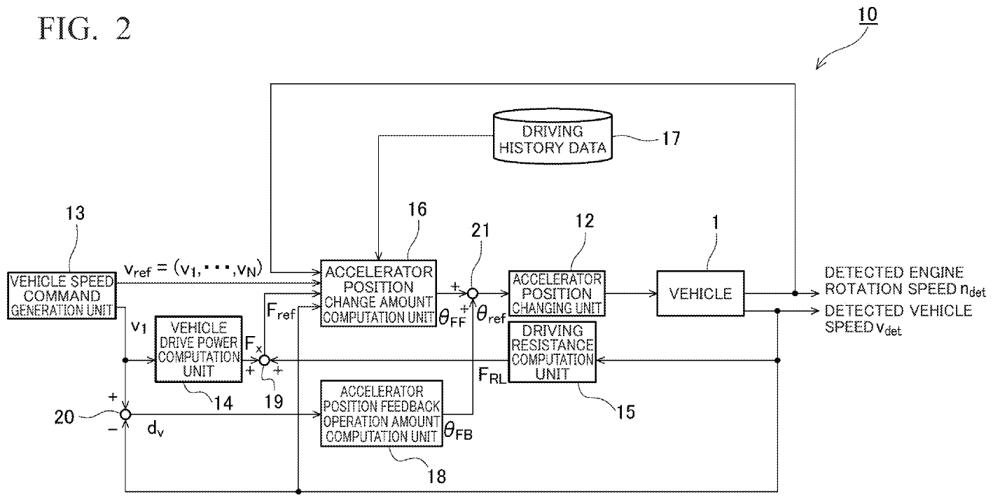

The control terminal 11 is an information processor having, thereinside, a structure as explained below using FIG. 2.

The accelerator position changing unit 12, in the present embodiment, is a drive robot installed on the driver seat 3 of the vehicle 1. The accelerator position changing unit 12 comprises an actuator 12a provided so as to be in contact with the accelerator pedal 4 of the vehicle 1. The accelerator position changing unit 12 changes and adjusts the accelerator position of the vehicle 1 by driving the actuator 12a in accordance with instructions from the control terminal 11 so as to operate the accelerator pedal 4.

FIG. 2 is a block diagram of the vehicle speed device 10. In the present embodiment, the vehicle speed control device 10 comprises, inside the control terminal 11, a vehicle speed instruction generation unit 13, a vehicle drive power computation unit 14, a driving resistance computation unit 15, an accelerator position change amount computation unit 16, driving history data 17, and an accelerator position feedback operation amount computation unit 18.

The vehicle speed command generation unit 13 generates vehicle speed commands based on information regarding a mode stored in the control terminal 11. The mode is represented, for example, by means of a table, a graph, or the like, as a relationship between, for example, the time elapsed since starting to drive and the vehicle speed to be reached at that time.

The vehicle speed command generation unit 13, within a time range from the current time to a future time that is a prescribed first time period in the future during the driving of the vehicle 1, generates vehicle speed commands by referring to the mode and determining vehicle speeds corresponding to times, within this range, separated by a prescribed first time interval. In the present embodiment, the prescribed first time period is, for example, 5 seconds, and the prescribed first time interval is, for example, 0.02 seconds.

Thus, the vehicle speed command generation unit 13 generates vehicle speed commands for multiple future times while the vehicle 1 is being driven. Thereafter, these multiple vehicle speed commands are arranged in the order of shortness of the time elapsed from the current time, and expressed as a vehicle speed command vector v_{ref}. In other words, for a vehicle speed command vector v_{ref}=(v₁, v₂, . . . , v_{N}), v₁ represents the vehicle speed command to be fulfilled next, the prescribed first time interval, for example, 0.02 seconds, after the current time, and v₂ represents the vehicle speed command, for example, 0.04 seconds thereafter. Additionally, v_{N} is the vehicle speed command, the prescribed first time period, for example, 5 seconds, after the current time.

The vehicle speed command generation unit 13 transmits the vehicle speed command vector v_{ref} to the accelerator position change amount computation unit 16.

Additionally, the vehicle speed command generation unit 13 transmits, to the vehicle drive power computation unit 14, the first element of the vehicle speed command vector v_{ref}, in other words, the vehicle speed command v₁, as the vehicle speed command v₁ of the next processing time, which is to be fulfilled next.

The vehicle drive power computation unit 14 receives the vehicle speed command v₁ for the next processing time from the vehicle speed command generation unit 13.

The vehicle drive power computation unit 14 computes the vehicle drive power Fₓ based on the vehicle speed command v₁ for the next processing time. More specifically, if the weight of the vehicle 1 is represented by Mᵥ (kg), then the vehicle drive power Fₓ can be approximately determined by the following expression:

$$\begin{matrix}[ Math . 1 ] & \\ {F}_{X} = \frac{{M}_{v}}{3.6} \frac{d}{dt} {v}_{1} & [ 1 ]\end{matrix}$$

In the above expression, the derivative of the vehicle speed command v₁ for the next processing time is calculated on the basis of the newest value of the vehicle speed command v₁ that the vehicle drive power computation unit 14 has received from the vehicle speed command generation unit 13 and the vehicle speed command v₁ received from the vehicle speed command generation unit 13 at the previous time, for example, by dividing the difference therebetween by a prescribed time value.

The driving resistance computation unit 15 detects and acquires the current vehicle speed v_{det} from the vehicle 1 being driven.

The driving resistance computation unit 15 computes a driving resistance F_{RL} simulating actual driving on an actual road surface based on the current vehicle speed v_{det}. More specifically, if A, B, and C are constants that are set for each vehicle, the driving resistance F_{RL} can be approximately determined by the following expression:

[Math. 2]

F_{RL}=A+BV_{det}+Cv²_{det} [2]

The driving resistance computation unit 15 transmits the driving resistance F_{RL} calculated by the above expression to the chassis dynamometer 5 so that a driving resistance force is generated with respect to the vehicle 1 being driven.

Thus, the driving resistance computation unit 15 computes a driving resistance F_{RL} in accordance with the current vehicle speed v_{det}.

The vehicle drive power Fₓ calculated by the vehicle drive power computation unit 14 and the driving resistance F_{RL} calculated by the driving resistance computation unit 15 are transmitted to an adder 19.

The adder 19 receives and adds these values to compute a requested drive power F_{ref}, which is the sum of the vehicle drive power Fₓ and the driving resistance F_{RL}.

The adder 19 transmits the requested drive power F_{ref} to the accelerator position change amount computation unit 16.

The accelerator position change amount computation unit 16 receives the vehicle speed command vector v_{ref} from the vehicle speed command generation unit 13 and the requested drive power F_{ref} from the adder 19. The accelerator position change amount computation unit 16 further acquires, from the vehicle 1 being driven, detection results for the current vehicle speed v_{det} and the current engine rotation speed n_{det}.

The accelerator position change amount computation unit 16 computes an accelerator position change amount on the basis of each of the received and acquired values. This accelerator position change amount is, strictly speaking, calculated by implementing feed-forward control on the basis of the vehicle speed command vector v_{ref} and the requested drive power F_{ref} calculated from the speed command v₁. Therefore, the accelerator position change amount calculated by the accelerator position change amount computation unit 16 will hereinafter be referred to as the feed-forward change amount (indicated as the FF change amount below) θ_{FF}.

In the present embodiment, the FF change amount θ_{FF} is the operation amount by which the accelerator pedal 4 should be operated by the accelerator position changing unit 12 in order to fulfill the vehicle speed command v₁ for the next processing time, as computed by feed-forward control.

The accelerator position change amount computation unit 16 computes the FF change amount θ_{FF} by means of a machine learning device that has been trained by using, as the training data, driving history data 17 obtained while actually driving the vehicle 1. In the present embodiment, the machine learning device is realized by a neural network.

The driving history data 17 has been recorded by actually measuring data while driving the vehicle 1, before or after the accelerator position changing unit 12 has been installed in the vehicle 1. The driving history data 17 includes measurement data for vehicle speeds, drive powers, and engine rotation speeds of the vehicle 1 while being driven.

The driving history data 17 is preferably obtained by measuring each of the values while the vehicle 1 is being driven in accordance with a mode. However, it is not necessarily essential for the vehicle 1 to have been driven in accordance with a mode.

As explained below, when computing an FF change amount θ_{FF} after having completed training and actually being installed in the vehicle 1, the machine learning device takes, as inputs, a vehicle command vector v_{ref}=(v₁, v₂, . . . , v_{N}), a requested drive power F_{ref}, a current vehicle speed v_{det}, and a current engine rotation speed n_{det}, which have been received.

When training this machine learning device, if the driving history data 17 has been obtained by taking actual measurements while driving the vehicle 1 in accordance with a mode, then the vehicle speed commands, drive powers, vehicle speeds, and engine rotation speeds obtained at the multiple future times at that time may be input, respectively, as the vehicle command vector v_{ref}, the requested drive power F_{ref}, the current vehicle speed v_{det}, and the current engine rotation speed n_{det}.

Alternatively, if the driving history data 17 has not been obtained by driving the vehicle 1 in accordance with a mode, then instead of vehicle speed commands, the vehicle speeds at the multiple future times should be input as the vehicle speed command vector v_{ref}. In other words, the future vehicle speeds in the driving history data 17 can be assumed to be provisionally provided vehicle speed commands and the driving history data 17 can be considered to be actual measurement results obtained in accordance with the provisionally applied vehicle speed commands. Even by such a method, it is possible to learn the relationship between the current accelerator position and future vehicle speeds. Thus, learning effects similar to the case in which the driving history data 17 has been obtained by taking actual measurements while driving the vehicle 1 in accordance with a mode can be expected.

Additionally, the driving history data 17 includes actual measurement data for FF change amounts θ_{FF} that are to be the outputs of the machine learning device. This actually measured data of the FF change amounts θ_{FF} is used as the correct values when training the machine learning device.

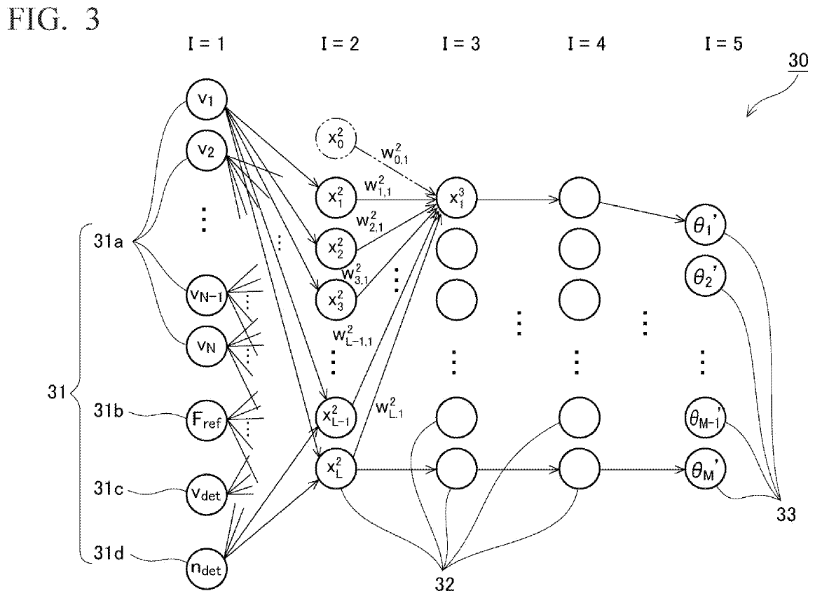

FIG. 3 is a diagram for explaining the machine learning device constituting the accelerator position change amount computation unit 16.

In the present embodiment, the machine learning device 30 is a fully connected neural network having five total layers, with three intermediate layers. In FIG. 3, the layers are represented by l, the layer in which l=1 is the input layer, the layers in which l=2, 3 and 4 are intermediate layers, and the layer in which l=5 is the output layer. Hereinafter, as seen from the l-th layer, the (l−1)-th layer will be referred to as the preceding layer.

The input nodes 31 forming the input layer include N first input nodes 31a, and one each of a second input node 31b, a third input node 31c and a fourth input node 31d.

The training of the machine learning device 30 will be explained first. In order to simplify the explanation below, it will be assumed that the driving history data 17 has been actually measured by driving the vehicle 1 in accordance with a mode. Even if the driving history data 17 has not been obtained by driving the vehicle 1 in accordance with a mode, a similar explanation is possible by using the future vehicle speeds as the vehicle speed commands, as already explained.

The number of the first input nodes 31a that are provided is the same as the number of elements in the vehicle speed command vector v_{ref}=(v₁, v₂, . . . , v_{N}) received by the accelerator position change amount computation unit 16. The vehicle speed commands for multiple future times in the driving history data 17 are respectively input to the first input nodes 31a.

Similarly, a drive power, a vehicle speed, and an engine rotation speed in the driving history data 17 are respectively input to the second input node 31b, the third input node 31c, and the fourth input node 31d.

In each of the nodes 32 in the intermediate layers, computations are performed based on values, from the nodes in the preceding layer (if l=2, then the input nodes 31 wherein l=1, and if l=3 or 4, then the nodes 32 wherein l=2 or 3), calculated at each of the nodes 31, 32 in the preceding layer, and on weightings from the nodes 31, 32 in the preceding layer to the nodes 32 in the relevant intermediate layer, and the computation results are stored in the nodes 32 in the relevant intermediate layer.

More specifically, if x^{l}ₚ denotes the value stored in the p-th node in the l-th layer, w^{l}_{p,q} denotes a transfer weighting from the p-th node in the l-th layer to the q-th node in the (l+1)-th layer, x^{l}₀ denotes a bias, and W^{l}_{0,q}, in other words, the transfer weighting from the bias in the l-th layer to the q-th node in the (l+1)-th layer is equal to one, then as a result of transfer from the l-th layer in the machine learning device 30 to the q-th node in the (l+1)-th layer, the value stored in the q-th node in the (l+1)-th layer can be computed by the following expression:

[Math. 3]

x_{q}^{l+1}=ƒ(Σₚw_{p,q}^{l}xₚ^{l}) [3]

In this case, the values x¹ᵢ (i=1 to N+3) stored in the first layer, i.e., in the nodes 31 in the input layer, are the values input to the first to fourth input nodes 31a, 31b, 31c, and 31d.

Additionally, the function f(x) is ReLU (Rectified Linear Unit), which is represented by the following expression:

[Math. 4]

ƒ(x)=max(0,x) [4]

FIG. 3 shows how values are transferred from the preceding layer, in other words, from the second layer, when l=2 and q=1 in Math. 3, i.e., when computing x³₁. In order to explain the calculation of x³₁, in the second layer in particular, the bias x²₀ and the transfer weighting w²_{0,1} from the bias x²₀ are indicated by double-dotted chain lines. The number of intermediate nodes 32 in each of the intermediate layers is appropriately determined so that the training using the driving history data 17 will be suitably performed.

In the output layer also, computations using Math. (3) are performed in a manner similar to the intermediate layers, and the computation results are stored in the respective output nodes 33.

In the present embodiment, the output layer is provided with a number of output nodes 33 indicated by M in FIG. 3, and the machine learning device 30 computes the FF change amounts at the multiple future times. In other words, at each output node 33 in the output layer, FF change amounts are computed for a total of M times, from an FF change amount θ′₁ that is a prescribed second time interval, for example, 0.002 seconds, after a basepoint at the current time, to an FF change amount θ′_{M} that is a prescribed second time interval, for example, 1 second, after the current time, at times separated by the prescribed second time interval.

These FF change amounts θ′₁ to θ′_{M} that are computed in the respective output nodes 33 are tentative. Among these tentative FF change amounts θ′₁ to θ′_{M}, the accelerator position change amount computation unit 16 applies, to the FF change amount θ′₁ corresponding to the next time period, in particular, a moving-average process, for example, with the output results from past processing, and outputs the results thereof as the FF change amount θ_{FF}. In other words, in the present embodiment, the values of θ′₂ to θ′_{M} are not used. However, they may be used in other modified examples, as will be explained below.

In the machine learning device 30, as described above, the driving history data 17 is input and training is performed in advance so that, after the FF change amounts θ′₁ to θ′_{M} have been computed, these values will be appropriate values, in other words, so that appropriate values can be computed when the FF change amounts θ′₁ to θ′_{M} are actually computed. In this training, the values of all of the weightings w¹_{p,q} and the value of the bias x¹₀ are adjusted. The training target is the actually measured data of the FF change amounts in the driving history data 17, and training is performed to minimize the squared error between the target data and the results computed by the respective output nodes 33. The training can be performed, for example, by error back-propagation.

The accelerator position change amount computation unit 16 computes the FF change amount θ_{FF} by means of the machine learning device 30 that is trained as described above.

In other words, the elements of the vehicle speed command vector v_{ref}=(v₁, v₂, . . . , v₃) received by the accelerator position change amount computation unit 16 are respectively input to the first input nodes 31a. Similarly, the requested drive power F_{ref}, the current vehicle speed v_{det}, and the current engine rotation speed n_{det} received by the accelerator position change amount computation unit 16 are respectively input to the second input node 31b, the third input node 31c, and the fourth input node 31d. Each of the input values is transferred to the next layer in the machine learning device 30 while being computed by Math. (3) and Math. (4), and the computation results, in other words, the tentative FF change amounts θ′₁ to θ′_{M}, are stored in the respective output nodes 33 in the output layer. Among these, the accelerator position change amount computation unit 16 applies, to the tentative FF change amount θ′₁ corresponding to the next time period, in particular, a moving-average process, for example, with the output results from past processing, and outputs the results thereof as the FF change amount θ_{FF}.

Thus, the machine learning device 30 forming the accelerator position change amount computation unit 16 is trained by using, as the training data, the driving history data 17 including drive powers, vehicle speeds, accelerator position change amounts, and engine rotation speeds of the vehicle while being driven.

Additionally, if the driving history data 17 has been actually measured by driving the vehicle 1 in accordance with a mode, then the vehicle speed commands for multiple future times are also used as training data.

In the accelerator position change amount computation unit 16 provided with a machine learning device 30 that has been trained in this manner, when a vehicle speed command vector v_{ref}, a requested drive power F_{ref}, a current vehicle speed v_{det}, and a current engine rotation speed n_{det} are input, these values are input to the input nodes 31a, 31b, 31c, and 31d of the machine learning device 30 to compute the FF change amount θ_{FF} by means of the machine learning device 30.

The accelerator position feedback operation amount computation unit 18 receives the difference between the current vehicle speed v_{det} and the vehicle speed command v₁ for the next processing time transmitted by the vehicle speed command generation unit 13, this difference being, in other words, a vehicle speed error dv which is the result of a subtraction process performed between these values by an adder 20.

The accelerator position feedback operation amount computation unit 18 computes an accelerator position feedback change amount (hereinafter referred to as the FB change amount) θ_{FB} that makes the vehicle speed error dv small by means of feedback control of the vehicle speed such as, for example, PID (Proportional-Differential Controller) control. The parameters used in PID control are adjusted in advance.

The FF change amount θ_{FF} computed by the accelerator position change amount computation unit 16 and the FB change amount θ_{FB} computed by the accelerator position feedback operation amount computation unit 18 are added by an adder 21 to calculate a change amount θ_{ref} that is actually to be used.

This change amount θ_{ref} is transmitted to the accelerator position changing unit 12 as an accelerator pedal operation command θ_{ref}. The accelerator position changing unit 12, on the basis of this accelerator pedal operation command θ_{ref}, in other words, the accelerator position change amount θ_{ref} that is actually to be used, particularly in the present embodiment, drives the actuator 12a to operate the accelerator pedal 4, thereby changing the accelerator position. As a result thereof, the vehicle speed and the engine rotation speed of the vehicle 1 change.

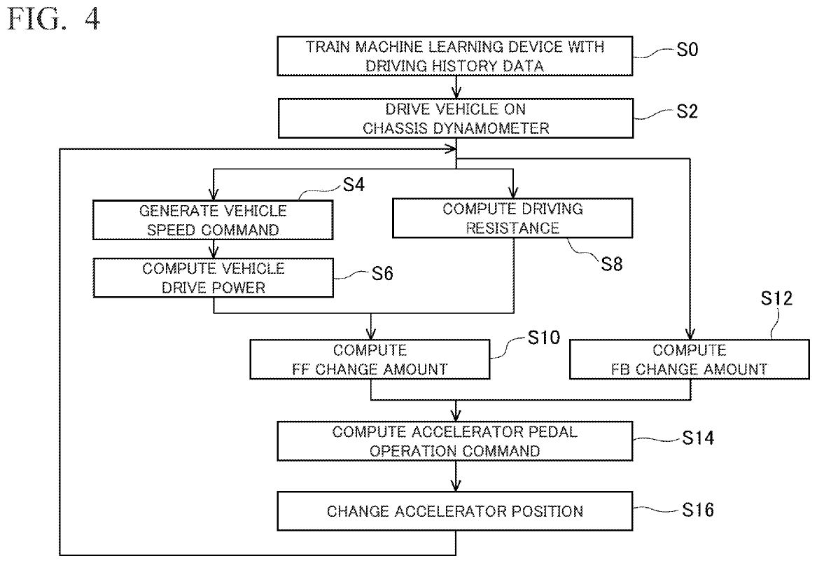

Next, using FIGS. 1 to 3 and 4, the vehicle speed control method using the above-described vehicle speed control device 10 will be explained. FIG. 4 is a flow chart of the vehicle speed control method.

The present vehicle speed control method controls the driving of a vehicle in accordance with a defined vehicle speed command by changing the accelerator position of the vehicle. The method involves: computing an accelerator position change amount based on a current vehicle speed and a requested drive power necessary to fulfill the vehicle speed command, computed based on the vehicle speed command, by using a machine learning device that has been trained by using, as training data, driving history data including drive powers, vehicle speeds, and accelerator position change amounts of the vehicle while being driven; and changing the accelerator position based on the accelerator position change amount.

First, the machine learning device 30 is trained by using the driving history data 17 as the training data (step S0). The driving history data 17 is obtained by actually measuring and recording data when driving the vehicle 1 in accordance with a mode before or after the accelerator position changing unit 12 has been installed in the vehicle 1. However, as already explained, it is not necessarily essential for the driving history data 17 to be obtained by driving the vehicle 1 in accordance with a mode.

When the training of the machine learning device 30 is completed, the vehicle 1 is actually driven on a chassis dynamometer 5 and the fuel consumption and exhaust gases are measured (step S2).

At this time, the vehicle speed command generation unit 13 first generates a vehicle speed command, more specifically, a vehicle speed command vector v_{ref}, on the basis of information relating to a mode stored in a control terminal 11 (step S4).

The vehicle speed command generation unit 13 transmits the vehicle speed command vector v_{ref} to the accelerator position change amount computation unit 16.

Additionally, the vehicle speed command generation unit 13 transmits, to the vehicle drive power computation unit 14, as a vehicle speed command v₁ for the next processing time, which is to be fulfilled next, the first element of the vehicle speed command vector v_{ref}, in other words, the vehicle speed command v₁.

The vehicle drive power computation unit 14 receives a vehicle speed command v₁ for the next processing time from the vehicle speed command generation unit 13.

The vehicle drive power computation unit 14 computes the vehicle drive power Fₓ on the basis of the vehicle speed command v₁ for the next processing time (step S6).

In parallel with the above-described steps S4 and S6, the driving resistance computation unit 15 computes the driving resistance F_{RL} on the basis of the current vehicle speed v_{det} (step S8).

The accelerator position change amount computation unit 16 receives the vehicle speed command vector v_{ref} from the vehicle speed command generation unit 13. The accelerator position change amount computation unit 16 also receives, from the adder 19, the requested drive power F_{ref}, which is the sum of the vehicle drive power Fₓ calculated by the vehicle drive power computation unit 14 and the driving resistance F_{RL} calculated by the driving resistance computation unit 15. The accelerator position change amount computation unit 16 further acquires, from the vehicle 1 being driven, the detection results for each of the current vehicle speed v_{det} and the current engine rotation speed n_{det}.

The accelerator position change amount computation unit 16 computes the FF change amount θ_{FF} on the basis of each of the received and acquired values (step S10). More specifically, the elements of the vehicle speed command vector v_{ref}=(v₁, v₂, . . . , v₃) are respectively input to the first input nodes 31a of the machine learning device 30. Additionally, the requested drive power F_{ref}, the current vehicle speed v_{det}, and the current engine rotation speed n_{det} are respectively input to the second input node 31b, the third input node 31c, and the fourth input node 31d. Each of the input values is transferred to the next layer in the machine learning device 30 while being computed by Math. (3) and Math. (4), and the computation results, in other words, the tentative FF change amounts θ′₁ to θ′_{M}, are stored in the respective output nodes 33 in the output layer. Among these, the accelerator position change amount computation unit 16 applies, to the tentative FF change amount θ′₁ corresponding to the next time period, in particular, a moving-average process, for example, with the output results from past processing, and outputs the results thereof as the FF change amount θ_{FF}.

In the present embodiment, the tentative FF change amounts θ′₂ to θ′_{M} other than the tentative FF change amount θ′₁ corresponding to the next time period are not output from the machine learning device 30 to the outside and are not used. At a time corresponding to θ′₂ in this process, the machine learning device 30 newly computes the tentative FF change amounts θ′₁ to θ′_{M} for that time, and the tentative FF change amount θ′₁ obtained then is output from the machine learning device 30 as the tentative FF change amount for that time, and used.

In parallel with the above-described steps S4 to S10, the accelerator position feedback operation amount computation unit 18 receives the vehicle speed error dv, which is the difference between the current vehicle speed v_{det} and the vehicle speed command v₁ for the next processing time transmitted by the vehicle speed command generation unit 13.

The accelerator position feedback operation amount computation unit 18 computes an accelerator position FB change amount θ_{FB} that makes the vehicle speed error dv small by implementing feedback control of the vehicle speed (step S12).

The FF change amount θ_{FF} computed by the accelerator position change amount computation unit 16 and the FB change amount θ_{FB} computed by the accelerator position feedback operation amount computation unit 18 are added by the adder 21 to calculate the change amount θ_{ref} that is actually to be used (step S14).

This change amount θ_{ref} is transmitted to the accelerator position changing unit 12 as an accelerator pedal operation command θ_{ref}. The accelerator position changing unit 12, on the basis of this accelerator pedal operation command θ_{ref}, in other words, the accelerator position change amount θ_{ref} that is actually to be used, particularly in the present embodiment, drives the actuator 12a to operate the accelerator pedal 4, thereby changing the accelerator position (step S16).

When step S16 is completed, the processing shifts to steps S4, S8, and S12. In other words, the vehicle speed v_{det} and the engine rotation speed n_{det} of the vehicle 1 are changed by the series of processes in steps S4 to S16. The new vehicle speed v_{det} and engine rotation speed n_{det} are detected, and the accelerator pedal operation command θ_{ref} for the next time is computed on the basis of these detected values. By repeating the series of processes in steps S4 to S16 at each time, the driving of the vehicle 1 is controlled in accordance with a mode.

Next, the effects of the above-described vehicle speed control device and vehicle speed control method will be explained.

The vehicle speed control device 10 according to the present embodiment controls the driving of the vehicle 1 so as to follow the defined vehicle speed commands v₁, v_{ref} by changing the accelerator position of the vehicle 1. The vehicle speed control device 10 is provided with: an accelerator position change amount computation unit 16 that computes an FF change amount (accelerator position change amount) θ_{FF} on the basis of the current vehicle speed v_{det} and the requested drive power F_{ref} necessary to fulfill the vehicle speed command v₁, computed on the basis of the vehicle speed command v₁; and an accelerator position changing unit 12 that changes the accelerator position based on the FF change amount θ_{FF}. The accelerator position change amount computation unit 16 computes the FF change amount θ_{FF} by means of the machine learning device 30, which is trained by using, as training data, the driving history data 17 including drive powers, vehicle speeds, and FF change amounts of the vehicle 1 while being driven.

Due to the above-described features, the machine learning device 30 is trained to compute an appropriate FF change amount θ_{FF} using, as training data, the driving history data 17 including drive powers, vehicle speeds, and FF change amounts of the vehicle 1 while being driven. Thus, the driving of the vehicle 1 can be controlled so as to follow the defined vehicle speed commands v₁, v_{ref}. This machine learning device 30 is able to compute an FF change amount θ_{FF} that can be considered to be appropriate without depending on the input values. Therefore, a FF change amount θ_{FF} that allows a vehicle speed command to be followed with higher precision can be computed compared to the case in which the accelerator position cannot be output without depending on interpolation for values other than those that have actually been measured, such as, for example, a drive power characteristic map.

Additionally, the accelerator position change amount computation unit 16 performs computations by means of the machine learning device 30. Thus, there is basically no limit on the number of elements that can be input. For this reason, for example, it is possible to employ, as inputs to the machine learning device 30, as many elements that can be considered to be related, for example, to the FF change amount θ_{FF} as possible. As a result thereof, it is possible to compute a FF change amount θ_{FF} that allows a vehicle speed command to be followed with higher precision.

Additionally, the machine learning device 30 is realized by means of a neural network.

Due to the above-described feature, the vehicle speed control device 10 can be more appropriately realized.

Additionally, the machine learning device 30 is further trained by using, as the training data, driving history data 17 including engine rotation speeds, and the accelerator position change amount computation unit 16 computes the FF change amount θ_{FF} further on the basis of the current engine rotation speed n_{det}.

For example, in the case in which the vehicle 1 has an automatic transmission, the gears are automatically changed in the vehicle 1, so the relationship between the accelerator position and the speed cannot be easily understood from the outside.

Due to the above-described feature, during the training, the machine learning device 30 is trained so as to compute the FF change amount θ_{FF} on the basis of the engine rotation speed. Due to the machine learning device 30 that has been trained in this way, the accelerator position change amount computation unit 16 computes the FF change amount θ_{FF} on the basis of the current engine rotation speed n_{det}. For this reason, even in the case in which the vehicle 1 has an automatic transmission, it is possible to perform computations that do not depend on the gear state in the vehicle 1. As a result thereof, it is possible to compute an FF change amount θ_{FF} that allows a vehicle speed command to be followed with higher precision.

Additionally, the machine learning device 30 is further trained by using, as the training data, driving history data 17 including vehicle speeds at multiple future times, or vehicle speed commands at multiple future times, and the accelerator position change amount computation unit 16 computes the FF change amount θ_{FF} further on the basis of the vehicle speed commands v_{ref} at the multiple future times.

Due to the above-described feature, during the training, the machine learning device 30 is trained so as to compute the FF change amount θ_{FF} on the basis of the vehicle speeds or the vehicle speed commands at the multiple future times. Due to the machine learning device 30 that has been trained in this way, the accelerator position change amount computation unit 16 computes the FF change amount θ_{FF} on the basis of the vehicle speed commands v_{ref} at the multiple future times. For this reason, when computing the FF change amount θ_{FF} for the next time, it is possible to take into consideration the speed commands v_{ref} to be fulfilled at times further in the future. As a result thereof, it is possible to compute FF change amounts F_{F} that allow vehicle speed commands to be followed with higher precision.

Additionally, the machine learning device 30 computes tentative FF change amounts (tentative accelerator position change amounts) θ′₁ to θ′_{M} for multiple future times, and the accelerator position change amount computation unit 16 computes the FF change amount θ_{FF} on the basis of the tentative FF change amounts θ′₁ to θ′_{M}. Due to the above-described feature, when computing the tentative FF change amount θ′₁ for the next time, the machine learning device 30 simultaneously computes the tentative FF change amounts θ′₂ to θ′_{M} for times further in the future. In other words, when training the machine learning device 30, if the training is performed so as to also compute predictions for times further in the future in addition to the tentative FF change amount θ′₁ for the next time, then the predictions for further times are taken into account as feature amounts in the machine learning device 30. Due to these feature amounts, the computation of the tentative FF change amount θ′₁ for the next time can be performed by taking into consideration the behavior at the future times. As a result thereof, it is possible to compute an FF change amount θ_{FF} that allows a vehicle speed command to be followed with higher precision.

Additionally, the machine learning device 30 computes the FF change amount θ_{FF} on the basis of only the FF change amount θ′₁ for the closest time, in other words, the next time, among the tentative FF change amounts θ′₁ to θ′_{M} at multiple future times.

Due to the above-described feature, for each time at which an FF change amount is necessary, a tentative FF change amount θ′₁ is always computed on the basis of the newest inputs, and this value is used. Thus, it is possible to compute an FF change amount θ_{FF} that allows a vehicle speed command to be followed with higher precision.

Additionally, the accelerator position change amount computation unit 16 applies, to the tentative FF change amount θ′₁ output from the machine learning device 30, a moving-average process with the output results from past processing, and outputs the results thereof as the FF change amount θ_{FF}.

Due to the above-described feature, transitions in the FF change amount θ_{FF} output by the accelerator position change amount computation unit 16 can be made smooth. As a result thereof, the accelerator position can be smoothly adjusted.

Additionally, a vehicle drive power computation unit that computes a vehicle drive power on the basis of a vehicle speed command, and a driving resistance computation unit that computes a driving resistance in accordance with the current vehicle speed are provided. The requested drive power is the sum of the vehicle drive power and the driving resistance.

Due to the above-described feature, the vehicle speed control device 10 can be more appropriately realized.

Additionally, the accelerator position changing unit is a drive robot that is installed on the driver seat of the vehicle and that operates an accelerator pedal by means of an actuator.

Due to the above-described feature, the vehicle speed control device 10 can be more appropriately realized.

### First Modified Example of Embodiment

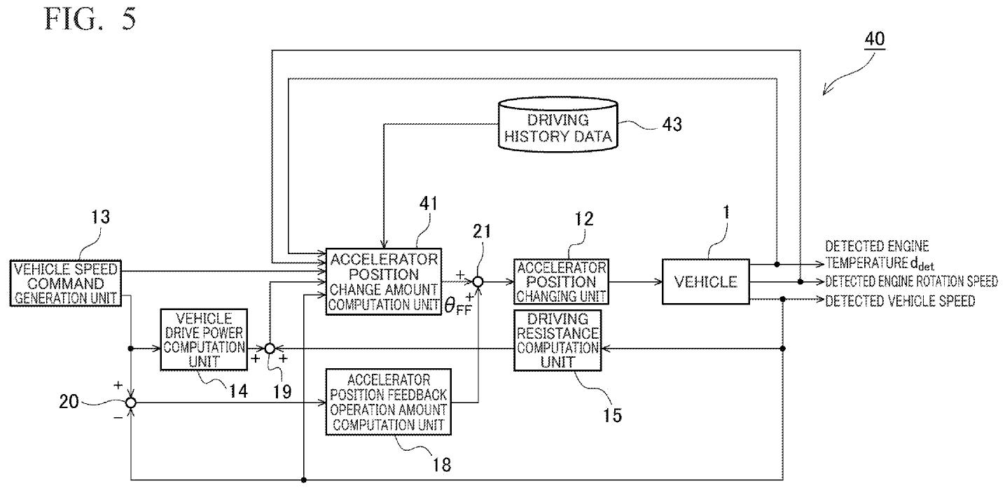

Next, using FIG. 5, a first modified example of the vehicle speed control device and the vehicle speed control method indicated as the above-described embodiment will be explained. FIG. 5 is a block diagram of the vehicle speed control device 40 in the present first modified example. The vehicle speed control device 40 in the present first modified example differs from the vehicle speed control device 10 of the above-described embodiment in that the accelerator position change amount computation unit 41 computes the FF change amount further on the basis of the current engine temperature d_{det}.

In association therewith, the machine learning device in the accelerator position change amount computation unit 41 has one additional input node corresponding to the engine temperature d_{det} as compared with the machine learning device 30 in the above-described embodiment. The driving history data 43 also stores, as actually measured values, engine temperatures that have been measured while driving the vehicle 1, and the machine learning device is trained with these engine temperatures as inputs. As a result thereof, the accelerator position change amount computation unit 41 is configured so as to be able to output an FF change amount θ_{FF} taking into consideration the current engine temperature d_{det}.

Thus, in the present first modified example, the machine learning device is further trained by using, as the training data, driving history data 43 including engine temperatures, and the accelerator position change amount computation unit 41 computes the FF change amount θ_{FF} further on the basis of the current engine temperature d_{det}.

Since engine output characteristics change non-linearly with the temperature, for a data structure that is constructed by depending on interpolation such as, for example, a drive power characteristic map, it is not easy to accurately account for this. Due to the above-described feature, the FF change amount θ_{FF} can be computed by taking into consideration changes in the characteristics that are dependent on the engine temperature.

Needless to say, the present first modified example provides other effects similar to those of the embodiment that have already been explained.

### Second Modified Example of Embodiment

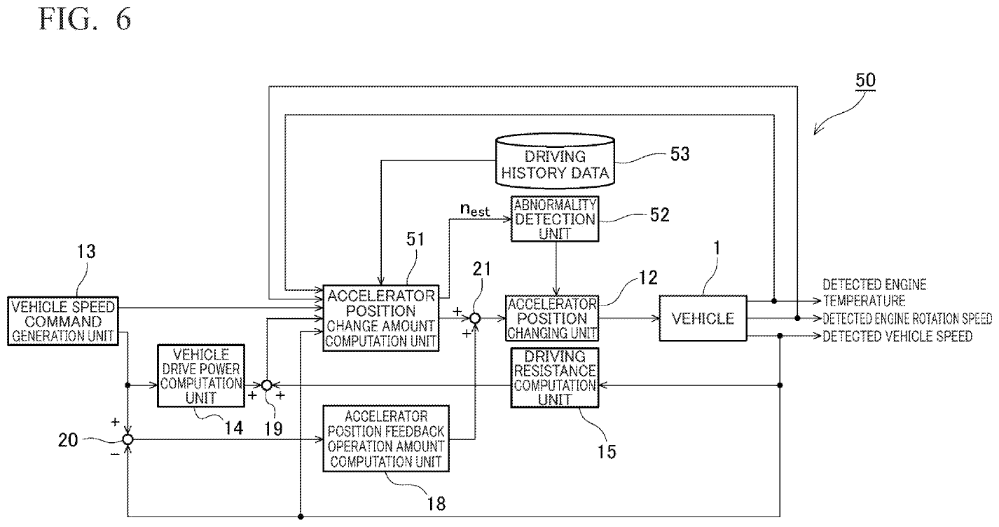

Next, using FIG. 6, a second modified example of the vehicle speed control device and the vehicle speed control method indicated as the above-described embodiment will be explained. FIG. 6 is a block diagram of the vehicle speed control device 50 in the present second modified example. The vehicle speed control device 50 according to the present second modified example is a further modification of the vehicle speed control device 40 in the above-described first modified example. The vehicle speed control device 50 differs in that an abnormality detection unit 52 is provided.

In the present second modified example, the machine learning device in the accelerator position change amount computation unit 51 is configured so as to predict and compute the engine rotation speeds nₑₛₜ=(n₁, n₂, . . . n_{M}) at multiple future times as compared with the machine learning device in the above-described first modified example. In association therewith, M output nodes corresponding to the engine rotation speeds nₑₛₜ are added in the machine learning device in the present second modified example. The driving history data 53 also stores the engine rotation speeds nₑₛₜ at the multiple future times as actually measured values, and these are used as the correct values to train the machine learning device.

Due to the above-described feature, the accelerator position change amount computation unit 51 computes the engine rotation speeds nₑₛₜ at the multiple future times. The accelerator position change amount computation unit 51 transmits, to the abnormality detection unit 52, the engine rotation speeds nₑₛₜ at the multiple future times that have been computed.

The abnormality detection unit 52 receives the engine rotation speeds nₑₛₜ at the multiple future times, and detects that there is an abnormality if there is an abnormal value.

More specifically, the abnormality detection unit 52 determines whether the values of the engine rotation speeds nₑₛₜ at multiple future times are abnormal by observing trends in the change in the values of the engine rotation speeds nₑₛₜ at the multiple future times or by comparing a minimum value or a maximum value with a prescribed threshold value.

In the case in which it is determined that there is an abnormality in the engine rotation speeds nₑₛₜ at multiple future times, the abnormality detection unit 52 transmits a stop signal to the accelerator position changing unit 12.

Thus, in the present second modified example, the accelerator position change amount computation unit 51 computes engine rotation speeds nₑₛₜ at multiple future times, and an abnormality detection unit 52 that detects cases in which the engine rotation speeds nₑₛₜ at multiple future times are abnormal values is provided.

Due to the above-described features, engine rotation speeds nₑₛₜ are predictively computed into the future, thereby allowing an operation to be cancelled in advance, before an operation for changing the accelerator position so as to result in an abnormal engine rotation speed is output. Thus, the occurrence of accidents or malfunctions in the vehicle 1 can be suppressed.

Needless to say, the present second modified example provides other effects similar to those of the embodiment and the first modified example that have already been explained.

### EXPERIMENTAL RESULTS

Next, experimental results using the vehicle speed control device 10 in the above-described embodiment will be explained.

Vehicle speed control was performed in accordance with a prescribed mode by means of both a device using a drive power characteristic map and the above-described vehicle speed control device 10, and the results thereof were compared.

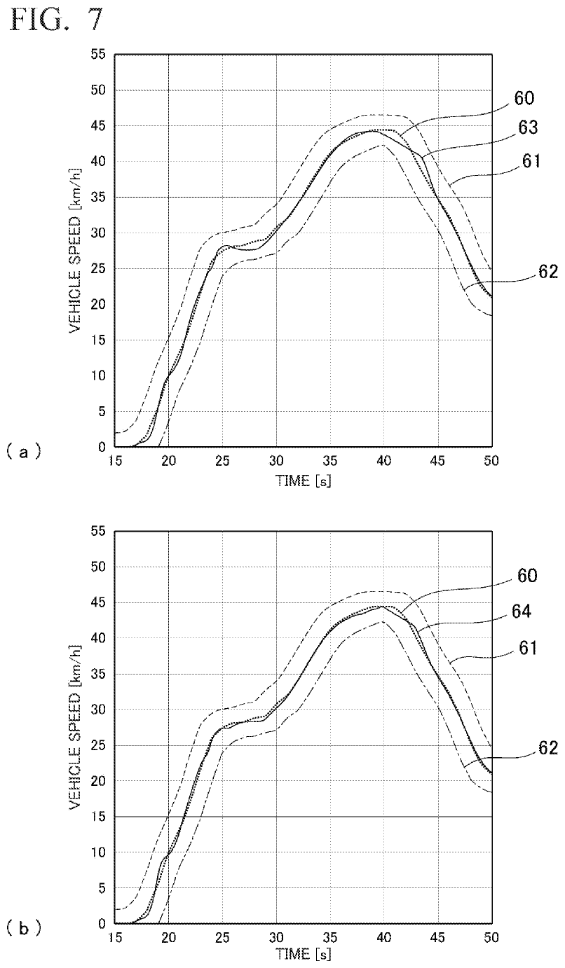

FIGS. 7(a) and (b) are graphs indicating the speed-following conditions in response to speed commands in both the device using a drive power characteristic map and the vehicle speed control device 10. In both FIGS. 7(a) and (b), the lines 60, 61 and 62 are respectively the speed command defined by the mode, the upper limit of the tolerable error range of the speed command, and the lower limit of the tolerable error range of the speed command. The line 63 in FIG. 7(a) indicates the speed-following conditions in the case of the device using the drive power characteristic map, and the line 64 in FIG. 7(b) indicates the speed-following conditions in the case of the vehicle speed control device 10.

The line 64 traces a curve that is closer to the line 60 than the line 63 does. More specifically, the average vehicle speed error with respect to the vehicle speed command 60 was 0.44 km/h for the speed-following conditions 63 in the case of the device using the drive power characteristic map, whereas the average vehicle speed error with respect to the vehicle speed command 60 was 0.28 km/h for the speed-following conditions 64 in the case of the vehicle speed control device 10. Thus, the vehicle speed control device 10 had speed-following properties in response to vehicle speed commands that were improved over those of the device using the drive power map.

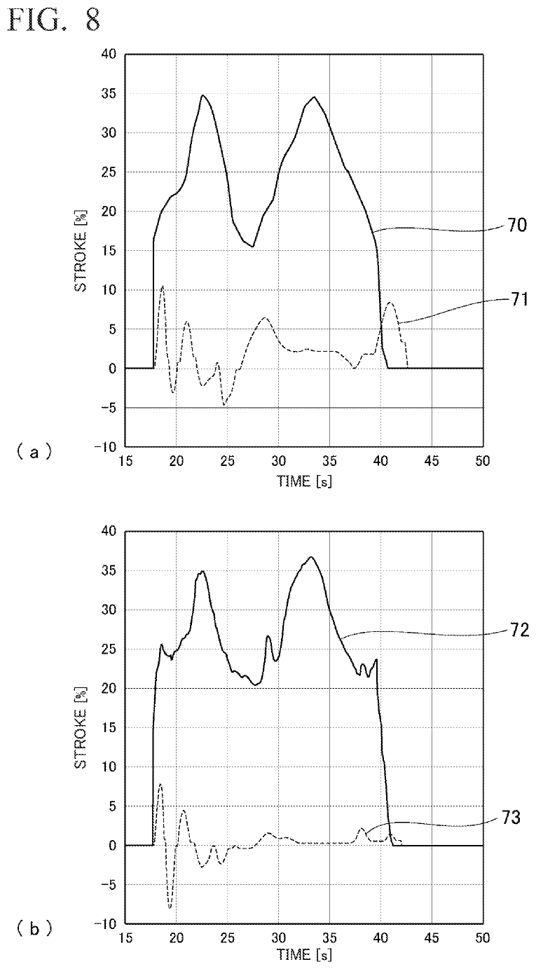

FIGS. 8(a) and (b) are graphs indicating the accelerator position operation amounts in both the device using the drive power characteristic map and the vehicle speed control device 10. The lines 70 and 71 are respectively the feed-forward operation amount and the feedback operation amount for the case of the device using the drive power characteristic map. Additionally, the lines 72 and 73 are respectively the feed-forward operation amount and the feedback operation amount for the case of the vehicle speed control device 10.

The line 73 has smaller values than the line 71 overall. In other words, in the case of the vehicle speed control device 10, the feedback operation amount is reduced. Thus, it can be understood that the precision is improved for feed-forward operation.

The vehicle speed control device and the vehicle speed control method of the present invention are not limited to the above-mentioned embodiment and modified examples explained with reference to the drawings, and various other modified examples may be contemplated within the technical scope thereof.

For example, in the above-described embodiment, it was explained that the driving history data 17 is included in the vehicle speed control device 10. However, it may be configured so as to be deleted and removed from the vehicle speed control device 10 when the training of the machine learning device 30 has been completed and the driving of the vehicle 1 is being controlled by actual operation.

Additionally, in the above-described embodiment, the vehicle speed command generation unit 13, the vehicle drive power computation unit 14, the driving resistance computation unit 15, the accelerator position change amount computation unit 16, the driving history data 17, and the accelerator position feedback operation amount computation unit 18 were configured to be provided in the control terminal 11. However, needless to say, the configuration is not limited thereto. The configuration may be such that some or all of the constituent elements are provided, for example, inside the accelerator position changing unit 12, and are operated by a CPU or the like provided in the accelerator position changing unit 12.

Additionally, the driving history data 17 may account for dynamic characteristics, which are the characteristics in the state in which the vehicle 1 is accelerating. Drive power characteristic maps are generally obtained by measuring and recording, in advance, the steady-state vehicle characteristics when the vehicle is driven with a constant accelerator position. Thus, it is difficult to account for dynamic characteristics. In contrast therewith, it is possible to output an FF change amount θ_{FF} that takes dynamic characteristics into account, for example, by training the machine learning device 30 in the vehicle speed control device 10 by using driving history data 17 in which dynamic characteristics are taken into account. As a result thereof, the computation precision of the FF change amount θ_{FF} can be further increased.

Additionally, in the above-described embodiment, the accelerator position change amount computation unit 16 applies, to the tentative FF change amount θ′₁ output from the machine learning device 30, a moving-average process with the output results from past processing, and outputs the results thereof as the FF change amount θ_{FF}. However, the invention is not limited to such a configuration. The machine learning device 30 computes tentative FF change amounts θ′₁ to θ′_{M} for multiple future times. Thus, a moving average may be calculated so as to include these future values in addition to the output results from past processing.

Additionally, in the above-described embodiment, the machine learning device 30 computes the FF change amount θ_{FF} on the basis of only the tentative FF change amount θ′₁ for the closest time, in other words, the next time, among the tentative FF change amounts θ′₁ to θ′_{M} for multiple future times. However, the invention is not limited to such a configuration. Within a range permitted by precision, it is possible to compute the multiple FF change amounts θ_{FF} on the basis of multiple tentative FF change amounts including θ′₁, and to actually use these values.

Aside from the above, it is possible to select whether to add or remove features indicated in the above-described embodiment and to appropriately modify the features to other features, as long as they do not depart from the spirit of the present invention.

For example, in the second modified example, a vehicle speed control device 50 in which an abnormality detection unit 52 was added to the configuration of the vehicle speed control device 40 in the first modified example was explained. However, it is possible to add the abnormality detection unit 52 to the vehicle speed control device 10 indicated as the embodiment.

### REFERENCE SIGNS LIST

1 Vehicle
3 Driver seat
4 Accelerator pedal
10, 40, 50 Vehicle speed control device
12 Accelerator position changing unit
14 Vehicle drive power computation unit
16, 41, 51 Accelerator position change amount computation unit
17, 43, 53 Driving history data
30 Machine learning device
52 Abnormality detection unit
v_{ref}, v₁, v₂, . . . , v_{N} Vehicle speed command
v_{det} Current vehicle speed
Fₓ Vehicle drive power
F_{RL} Driving resistance
F_{ref} Requested drive power
θ_{FF} Feed-forward change amount (accelerator position change amount)
θ′₁ to θ′_{M} Tentative feed-forward change amount (tentative accelerator position change amount)
n_{det} Current engine rotation speed
nₑₛₜ, n₁, n₂, . . . , n_{L} Engine rotation speed
d_{det} Current engine temperature

1. A vehicle speed control device for controlling driving of a vehicle in accordance with a defined vehicle speed command by changing an accelerator position of the vehicle, wherein the vehicle speed control device comprises:
an accelerator position change amount computation unit that computes an accelerator position change amount based on a current vehicle speed and a requested drive power necessary to fulfill the vehicle speed command, computed based on the vehicle speed command; and
an accelerator position changing unit that changes the accelerator position based on the accelerator position change amount;
the accelerator position change amount computation unit computing the accelerator position change amount by using a machine learning device that has been trained by using, as training data, driving history data including drive powers, vehicle speeds, and accelerator position change amounts of the vehicle while being driven;
the machine learning device being further trained by using, as the training data, the driving history data including vehicle speeds at multiple future times or vehicle speed commands at multiple future times; and
the accelerator position change amount computation unit computing the accelerator position change amount based on the vehicle speed commands at the multiple future times.

2. The vehicle speed control device according to claim 1, wherein the machine learning device is realized by a neural network.

3. The vehicle speed control device according to claim 1, wherein:
the machine learning device is further trained by using, as the training data, the driving history data including engine rotation speeds; and
the accelerator position change amount computation unit computes the accelerator position change amount further based on the current engine rotation speed.

4. (canceled)

5. The vehicle speed control device according to claim 1, wherein:
the machine learning device computes tentative accelerator position change amounts for multiple future times; and
the accelerator position change amount computation unit computes the accelerator position change amount based on the tentative accelerator position change amounts.

6. The vehicle speed control device according to claim 5, wherein:
the accelerator position change amount computation unit computes engine rotation speeds for multiple future times; and
the vehicle speed control device comprises an abnormality detection unit that detects cases in which the engine rotation speed at multiple future times is an abnormal value.

7. The vehicle speed control device according to claim 1, wherein:
the machine learning device is further trained by using, as the training data, the driving history data including engine temperatures; and
the accelerator position change amount computation unit computes the accelerator position change amount further based on the current engine temperature.

8. The vehicle speed control device according to claim 1, comprising:
a vehicle drive power computation unit that computes a vehicle drive power based on the vehicle speed command; and
a driving resistance computation unit that computes a driving resistance in accordance with the current vehicle speed;
wherein the requested drive power is the sum of the vehicle drive power and the vehicle driving resistance.

9. The vehicle speed control device according to claim 1, wherein the accelerator position changing unit is a drive robot that is installed on a driver seat of the vehicle and that operates an accelerator pedal by using an actuator.

10. A vehicle speed control method for controlling driving of a vehicle in accordance with a defined vehicle speed command by changing an accelerator position of the vehicle, wherein the vehicle speed control method comprises:
computing an accelerator position change amount based on a current vehicle speed, vehicle speed commands at multiple future times, and a requested drive power necessary to fulfill the vehicle speed command, computed based on the vehicle speed command, by using a machine learning device that has been trained by using, as training data, driving history data including drive powers, vehicle speeds, and accelerator position change amounts of the vehicle while being driven, the machine learning device being further trained by using, as the training data, the driving history data including vehicle speeds at multiple future times or the vehicle speed commands at multiple future times; and
changing the accelerator position based on the accelerator position change amount.
